(19) United States
(12) Patent Application Publication
(10) Pub. No.: US 2024/0326172 A1
(43) Pub. Date: Oct. 3, 2024

(54) LASER CUTTING PROCESS FOR DIVIDING A METAL SHEET INTO AT LEAST ONE WORKPIECE AND A PLURALITY OF RESIDUAL PORTIONS, AND LASER PROCESSING INSTALLATION

(71) Applicant: TRUMPF Werkzeugmaschinen SE + Co. KG, Ditzingen (DE)

(72) Inventor: Patrick Mach, Korb (DE)

(21) Appl. No.: 18/738,086

(22) Filed: Jun. 10, 2024

Related U.S. Application Data
(63) Continuation of application No. PCT/EP2022/084091, filed on Dec. 1, 2022.

(30) Foreign Application Priority Data
Dec. 15, 2021 (DE) 10 2021 133 319.9

(51) Int. Cl. B23K 26/38; B23K 26/359; B23K 101/18

(52) U.S. Cl. CPC B23K 26/38; B23K 26/359; B23K 2101/18

(57) ABSTRACT

A laser cutting process for cutting at least one workpiece out of a metal sheet while leaving a residual part is provided. The process includes arranging the metal sheet on a support of a laser cutting machine, introducing at least one cutting line for separating the at least one workpiece from the residual part using the laser cutting machine, and introducing at least one separating line into the residual part using the laser cutting machine. In a main region of the separating line, the residual part is cut through. In a connecting region of the separating line, at least one joint remains between mutually adjacent portions of the residual part. The joint has a height that is smaller than a thickness of the metal sheet. The process further includes removing the residual part from the support, and separating the portions of the residual part from one another.

### CROSS REFERENCE TO RELATED APPLICATIONS

This application is a continuation of International Application No. PCT/EP2022/084091 (WO 2023/110440 A1), filed on Dec. 1, 2022, and claims benefit to German Patent Application No. DE 10 2021 133 319.9, filed on Dec. 15, 2021. The aforementioned applications are hereby incorporated by reference herein

### FIELD

Embodiments of the invention relate to a laser cutting process for cutting at least one workpiece out of a metal sheet while leaving a residual part.

Embodiments of the invention further relate to a laser processing installation having a laser cutting machine, a loading and unloading apparatus and a control device.

### BACKGROUND

A laser cutting process is known from JPH 09300300 A.

In 2D laser cutting, before or after the good parts (workpieces) are cut, a scrap skeleton is conventionally divided into smaller regions which, owing to their lower weight, can be unloaded from a workpiece support manually or in an automated manner more easily than the residual sheet as a whole. Large inner regions of good parts, so-called “waste parts” or “slugs”, can also be cut into smaller parts so that they can subsequently be removed more easily.

However, when cutting the scrap skeleton, strip-shaped scrap skeleton regions can be formed, and these regions hang down between support bars of the workpiece support if they are not supported sufficiently by the support bars of the workpiece support. This can result in a collision with grippers or rakes of a removal unit. The unloading of such scrap skeleton regions becomes more difficult or even impossible.

It is often out of the question to dispense with the shredding of the scrap skeleton, since the scrap skeleton with the external dimensions of the metal sheet poses problems on disposal. The size of the scrap skeleton as a whole in the unshredded state will thus typically exceed charging dimensions for scrap.

It is known from JPH 09300300 A mentioned at the outset, in the case of punching or in the case of laser cutting, to provide a residual part that is left behind with microjoints in order to allow the residual part to be divided into smaller pieces. The microjoints can be formed by punching holes in the residual part.

### SUMMARY

Embodiments of the present invention provide a laser cutting process for cutting at least one workpiece out of a metal sheet while leaving a residual part. The process includes arranging the metal sheet on a support of a laser cutting machine, introducing at least one cutting line for separating the at least one workpiece from the residual part using the laser cutting machine, and introducing at least one separating line into the residual part using the laser cutting machine. In a main region of the separating line, the residual part is cut through. In a connecting region of the separating line, at least one joint remains between mutually adjacent portions of the residual part. The joint has a height that is smaller than a thickness of the metal sheet. The process further includes removing the residual part from the support, and separating the portions of the residual part from one another.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a laser processing installation having a laser cutting machine and a loading and unloading apparatus when carrying out a process according to embodiments of the invention, in a schematic perspective view;

FIG. 2 shows a schematic sectional view through a metal sheet in the region of a separating line between two portions of a residual part, wherein a joint between the two portions does not extend over the entire thickness of the metal sheet, according to some embodiments;

FIG. 3 shows a metal sheet with a plurality of cutting lines for cutting out workpieces and with a plurality of separating lines for dividing a residual part that is left behind after the workpieces have been cut out into a plurality of portions, wherein the portions of the residual part are held together by joints of small height, in a schematic top view, according to some embodiments;

FIG. 4 shows a further metal sheet with a plurality of cutting lines and a plurality of separating lines, wherein the cutting and separating lines, for a continuous cutting operation without piercing, always begin at an outer edge of the metal sheet or in a region of the metal sheet that has already been cut through, in a schematic top view, according to some embodiments;

FIG. 5 shows the top left region of FIG. 4 in an enlarged representation, with the cutting sequence marked, according to some embodiments; and

FIG. 6 shows a schematic flow diagram of a process according to embodiments of the invention.

### DETAILED DESCRIPTION

Embodiments of the invention can make it possible for the remainder of a metal sheet that is left behind after workpieces have been cut out to be removed and shredded in a reliable manner.

According to embodiments of the invention, a laser cutting process is provided. Within the scope of the process, at least one workpiece is cut out of a metal sheet, wherein at least one residual part is left behind.

The metal sheet typically consists of metal. The metal sheet can in particular consist of steel. A thickness of the metal sheet can be at least 4 mm, preferably at least 10 mm, preferably at least 20 mm, preferably at least 40 mm. The thickness of the metal sheet can be not more than 150 mm, in particular not more than 120 mm. An edge length of the metal sheet, in particular the largest edge length, can be at least 1 m, preferably at least 2 m, preferably at least 3 m, preferably at least 5 m.

The process comprises the following steps:
A) arranging the metal sheet on a support of a laser cutting machine;
B) introducing at least one cutting line for separating the at least one workpiece from the residual part and
introducing at least one separating line into the residual part, wherein in a main region of the separating line the residual part is cut through and wherein in a connecting region of the separating line at least one joint remains between mutually adjacent portions of the residual part, said joint having a height which is smaller than a thickness of the metal sheet;
C) removing the entire residual part from the support;
D) separating the portions of the residual part from one another.

Steps A) to D) are carried out in the specified sequence. The at least one cutting line and the at least one separating line can be introduced in step B) in any sequence or also in some portions in an alternating manner.

In step A), the metal sheet is placed on the support of the laser cutting machine. The metal sheet can be fixed to the support. The support typically has discrete support means, for example bars running parallel to and spaced apart from one another, for locally limited support of the metal sheet. The laser cutting machine can be a 2D flat bed machine.

In step B), a laser beam is directed onto the metal sheet. The laser beam can be emitted by a processing head of the laser cutting machine. The point of impact of the laser beam on the metal sheet is moved along the cutting line and the separating line. To this end, the processing head can be displaced relative to the support.

Together with the laser beam, a jet of cutting gas, for example nitrogen and/or oxygen, can be directed onto the metal sheet. The laser beam and the jet of cutting gas can be emitted together from a cutting gas nozzle of the processing head.

The at least one cutting line defines the shape, in particular an outer contour and optionally an inner contour, of the at least one workpiece. The residual part, or one of the residual parts, can be a scrap skeleton formed outside the at least one workpiece. Alternatively or in addition, the residual part, or one of the residual parts, can be a waste part (a so-called slug) formed inside the workpiece.

The metal sheet is typically cut through completely over the entire length of the at least one cutting line. However, it can also be provided that the workpiece initially remains connected to the residual part in places.

In a main region of the separating line, the residual part, or the metal sheet, is cut through. The main region typically comprises more than 90%, preferably more than 95%, preferably more than 98%, of the length of the separating line. In at least one connecting region of the separating line, at least one joint remains between adjacent portions of the residual part, said joint having a height which is smaller than a thickness of the metal sheet. Such a joint is also referred to hereinbelow as a “nanojoint” or as a “joint of small height”. The laser beam is in principle not switched off as it moves along a segment of the separating line. Material is removed at every point of the separating line. The joint is formed in principle on the side of the residual part, or of the metal sheet, that is remote from the point of impact of the laser beam. In other words, the portions of the residual part remain connected together, wherein the joint does not extend over the entire thickness of the metal sheet, or of the residual part. Because the mutually adjacent portions are connected, tilting of individual portions of the residual part can be prevented.

Preferably, the laser power is reduced in the connecting region of the separating line in order to obtain the joint of small height. Alternatively or in addition, a cutting speed can be increased or a distance between a cutting gas nozzle, through which the laser beam and a jet of cutting gas are directed onto the metal sheet, or the workpiece, and the metal sheet can be increased. As a result of these parameter changes, complete cutting through of the metal sheet is avoided in a locally limited manner. The parameter change(s) for producing the joint of small height can be performed as described in WO 2019/025327 A2. In this respect, reference is made to the description of WO 2019/025327 A2, wherein the joints referred to here as joints of small height or “nanojoints” are referred to in WO 2019/025327 A2 as “microjoints”.

In step C), the entire residual part is removed from the support. In other words, the totality of the mutually connected portions of the residual part is removed as a whole from the support. Because the portions are connected, this can be carried out in a simple manner. A removal apparatus does not need to engage with each individual portion but only with one point or optionally a plurality of points of the assembly. The removal can preferably be carried out with a mechanical gripper. Prongs, forks or hooks of the gripper can be pushed under the residual part so that the residual part as a whole can be lifted and removed from the support. The gripper can be configured in the manner of a rake. It will be appreciated that other grippers, for example vacuum grippers or magnetic grippers, could also be used. Manual removal is also possible.

Then, in step D), the portions of the residual part are separated from one another. In other words, the portions of the residual part are singularized. Because of the small height of the joint(s), separation can be carried out in a simple manner, in particular with little force. Separation can be carried out manually, for example by tilting the portions relative to one another. Alternatively, separation can be carried out in an automated manner, for example with a breaker. Separation of the portions of the residual part from one another can be carried out over a collection container for scrap. A largest extent of the individual portions of the residual part can be not more than 1.5 m, preferably not more than 1 m. The above-mentioned measures facilitate disposal.

The process according to embodiments of the invention ensures that the individual portions of the residual part cannot tilt on the support because they are connected together. Disruptions in the work flow are thus avoided. The joints of the portions of the residual part additionally make it possible for the entire residual part to be removed in a simple manner. The stability of the joints of small height is sufficiently great that the entire residual part can be handled as a unit. At the same time, the joints of small height are sufficiently weak, so that the portions of the residual part can easily be separated from one another after the residual part has been removed from the laser cutting machine. In addition, the joints of small height can be produced efficiently. In contrast to joints that extend over the entire thickness of the metal sheet, separate piercing and movement after the joint has been produced are not necessary in the case of joints of small height. Compared with a connection of the portions of the residual part with joints that extend over the entire thickness of the metal sheet, productivity can be increased by more than 3% by the provision of joints of small height.

A height of the joint of small height can be not more than half, preferably not more than two fifths, preferably not more than one third, of the thickness of the metal sheet. In particular, the height of the joint can be not more than 10 mm, preferably not more than 5 mm. Typically, the height of the joint is at least one tenth, preferably at least one quarter, of the thickness of the metal sheet. In particular, the height of the joint can be at least 1 mm, preferably at least 2 mm. A length, measured along the separating line, of the joint of small height can be not more than half, preferably not more than one third, and/or at least one quarter of the thickness of the metal sheet. With a joint of such dimensions, the portions of the residual part can on the one hand securely be held together. On the other hand, the residual part can be shredded in a simple manner.

Preferably, the at least one workpiece is removed from the support between steps B) and C). In this case, the cutting lines cut through the metal sheet in principle over its entire length. Separate removal of the workpiece and of the residual part can facilitate further handling.

An uninterrupted separating length of the main region of the separating line can be not more than 400 mm, preferably not more than 300 mm. In other words, at least one joint of small height remains every 400 mm, preferably every 300 mm. The maximum distance between two joints of small height is thus not more than 400 mm, preferably not more than 300 mm, provided that a segment of the separating line exceeds this length. Correspondingly, the distance of a joint of small height from an outer edge of the metal sheet is also not more than 400 mm, preferably not more than 300 mm. Sufficient stability of the assembly of the portions of the residual part can thus be obtained.

In step B), two intersecting separating lines can be introduced. Preferably, at least one joint of small height remains in each separating line at a point of intersection of the separating lines. Preferably, two joints of small height remain in each separating line at the point of intersection. In this manner, a stable residual part can be obtained, which can nevertheless easily be shredded. The distance of the joints of small height from the point of intersection can be in particular not more than 5 cm, preferably not more than 3 cm, preferably not more than 2 cm.

The at least one separating line can reach an outer edge of the metal sheet and intersect a further separating line or the at least one cutting line at a point of intersection. Preferably, at least one joint of small height in this case remains between the point of intersection and the outer edge of the metal sheet. The outer portions of the residual part are thus fixed to one another. In particular when a removal apparatus engages the residual part from outside, sufficient stability of the residual part can thus be ensured.

Preferably, when the at least one cutting line and the at least one separating line are introduced, cutting always begins at an outer edge of the metal sheet or at a point of the metal sheet that has already been cut through. The point of the metal sheet that has already been cut through can be located on a cutting line or in the main region of a separating line that has already been produced. Time-consuming piercing of the metal sheet with the laser beam can thus be avoided. Processing of the metal sheet is thus accelerated considerably. In addition, the risk, which exists during piercing, of the occurrence of splatters which could reach the workpiece is avoided.

The separating line can reach the cutting line. In other words, the at least one separating line can extend as far as the workpiece. The length of the separating line that is required to divide the residual part can thus be reduced. This increases productivity.

Preferably, the introduction of the cutting line and the introduction of the separating line are carried out in a continuous cutting operation. To this end, the laser beam can be guided without interruption along the separating line and the cutting line. The separating line and the cutting line can thus be produced without interrupting the cutting operation. In particular, further piercing is not required.

The joint of small height can be formed adjacent to the cutting line. Damage to the workpiece, or interruptions to its contour, during cutting of the separating line up to the workpiece can thus be avoided. The cutting operation, with formation of the joint of small height, can move from the separating line into the cutting line and vice versa without the laser beam being interrupted. By contrast, the production of a joint extending over the entire height would require laborious piercing with the risk of splatters falling onto the workpiece.

Two workpieces which are spaced apart from one another by not more than 10 mm, preferably not more than 5 mm, preferably not more than 3 mm, can be cut out of the metal sheet. The utilization of the metal sheet is thus improved. The separating line with the joint of small height can be introduced between these two workpieces. In particular, the joint of small height is here also located in the region in which the two workpieces have the above-mentioned small spacing from one another. In this manner, connection of the portions of the residual part can also be achieved at such a point, in particular wherein the separating line runs from the cutting line of one workpiece to the cutting line of the other. It would not be possible to produce a joint that extends over the entire height of the metal sheet in workpieces arranged close to one another in this way, because the required piercing operation would involve the risk of damage to the workpieces.

A laser processing installation having a laser cutting machine, a loading and unloading apparatus and a control device also falls within the scope of the present invention. The control device is programmed to activate the laser cutting machine and the loading and unloading apparatus to carry out steps A) to C) of an above-described process according to embodiments of the invention. The loading and unloading apparatus serves to carry out steps A) and C). The laser cutting machine serves to carry out step B). The laser processing installation can further have a separating apparatus. The separating apparatus serves to carry out step D). The control device is advantageously programmed to activate the separating apparatus to carry out step D).

According to embodiments of the invention, the features mentioned above and those specified hereinbelow can each be used on its own or a plurality of such features can be used in any desired, expedient combinations. The embodiments shown and described are not to be interpreted as being exhaustive but instead are of an exemplary nature.

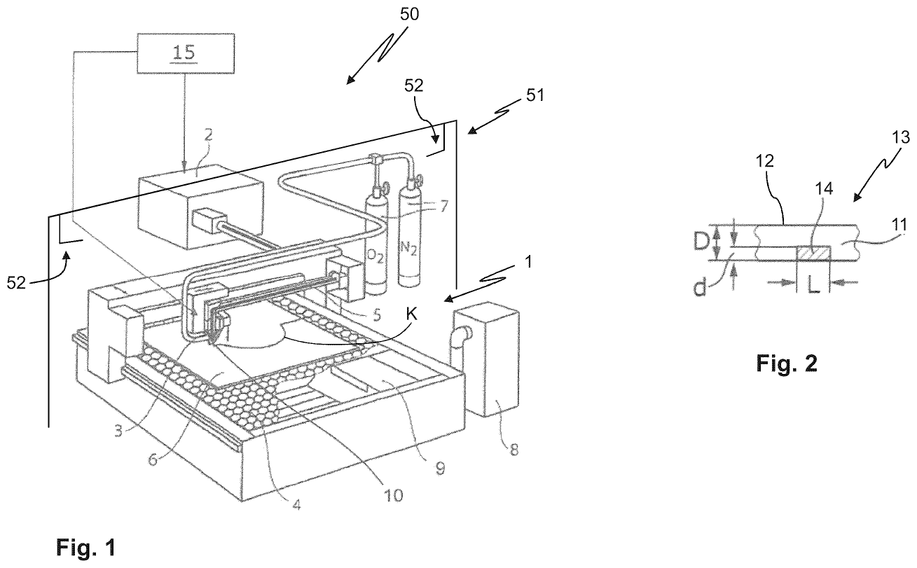

The laser cutting machine 1 shown in perspective in FIG. 1 has, for example, a CV laser, diode laser or solid-state laser as the laser beam generator 2, a movable (laser) processing head 3 and a support 4. A laser beam 5 is generated in the laser beam generator 2 and is guided by means of a light-conducting cable (not shown) or deflection mirrors (not shown) from the laser beam generator 2 to the processing head 3. A metal sheet 6 is arranged on the support 4. In order to bring the metal sheet 6 to the support 4, a laser processing installation 50 having the laser cutting machine I can have a loading and unloading apparatus 51. The loading and unloading apparatus 51 is here shown by way of example in the manner of a movable gantry having mechanical grippers 52 for gripping the metal sheet 6 from beneath.

The laser beam 5 is directed onto the metal sheet 6 by means of an optical focusing system arranged in the processing head 3. The laser cutting machine 1 is additionally supplied with cutting gases 7, for example oxygen and nitrogen. The use of a particular cutting gas 7 is dependent on the material of the metal sheet 6 and on quality requirements of the cut edges. A suction device 8 is further present, said suction device being connected to a suction channel 9 located beneath the support 4. The cutting gas 7 is fed to a cutting gas nozzle 10 of the processing head 3, from which it is emitted together with the laser beam 5.

During laser cutting, the metal sheet 6 is cut along a desired curve K by means of the laser beam 5 with a laser power (cutting power) sufficient to cut through the metal sheet. The curve can form a cutting line at a workpiece to be cut out and/or a separating line between portions of a residual part that is left behind. In the present case, the laser beam 5 is moved, but alternatively or in addition the metal sheet 6 is also moved.

As is shown in FIG. 2, during laser cutting of the metal sheet 6, joints 14 in the form of webs, or nanojoints, are left in a separating line 11 between mutually adjacent portions 12 of a residual part 13 of the metal sheet 6. The joints 14 fix the portions 12 of the residual part 13 to one another and thus prevent tilting relative to the adjacent portion 12 or the support 4. In addition, because of the joints 14, the residual part 13 can be handled in the assembly.

As is shown in FIG. 2, the nanojoint 14 does not extend over the entire thickness D of the metal sheet 6 but here extends only in the bottom third, that is to say it has a smaller height d than the thickness D. Therefore, the nanojoint is here also referred to as a joint 14 of small height. A length L of the nanojoint 14 is smaller along the separating line 11 than the thickness D; preferably, the length L of the nanojoint 14 is less than half the thickness D.

The length region of the curve K in which the nanojoints 14 are formed is here also referred to as a connecting region of the separating line 11. The length region of the separating line 11 in which the metal sheet 6 is cut through completely is also referred to as a main region of the separating line 11.

The production of the joints 14 will be described hereinbelow using the example of the variation of the laser power. In this variant of the process, the nanojoints 14 are generated solely by purposive adaptation of the laser power during the cutting process by means of suitably chosen power gradients, which are specified by a control device 15, shown in FIG. 1, of the laser cutting machine 1 in dependence on the workpiece material. The control device 15 also controls the movement of the processing head 3 relative to the metal sheet 6, and the loading and unloading apparatus 51.

Owing to the reduced laser power, the energy input per unit length required for a complete cut is no longer available for the cutting process. The material is therefore not melted over the entire thickness D of the metal sheet 6 but only in a top region. Instead, a nanojoint 14 between the adjacent portions 12 of the residual part 13 remains in the bottom region of the separating line 11, or the cutting edge.

Apart from the laser power, all the other cutting parameters of the laser cutting can remain unchanged during production of the nanojoint 14, that is to say, for example, the focal position of the laser beam 5, the distance of the cutting gas nozzle 10 from the workpiece surface, the cutting gas pressure and the cutting speed. After the nanojoint 14 has been produced, cutting is continued with the standard parameters.

In order to produce the nanojoint 14 with a smaller height d than the sheet thickness D, the laser power of the laser beam 5 during laser cutting of the metal sheet 6 is reduced, in a section of the curve K corresponding to the length L of the nanojoint 14, from the higher laser power (cutting power) that is sufficient to cut through the metal sheet 6 to a lower laser power (reduced power) that is not sufficient to completely cut through the metal sheet 6, and is then increased to the higher laser power (cutting power) again. During processing with the lower laser power (reduced power), a depression is produced in the metal sheet 6 above the nanojoints 14.

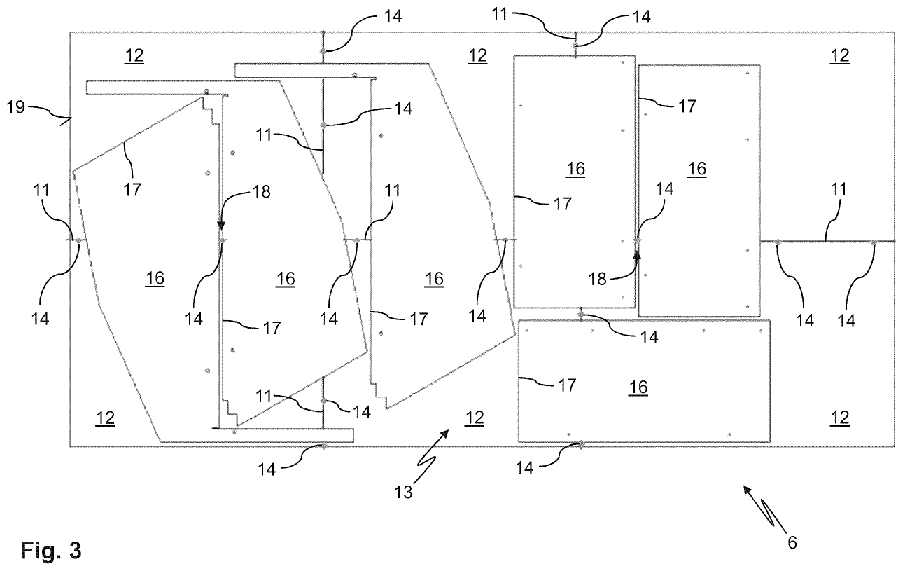

FIG. 3 shows a metal sheet 6 after laser cutting. A plurality of workpieces 16 have been cut out along cutting lines 17. The cutting lines 17 can each form an outer contour or an inner contour of the associated workpiece 16.

The remaining region of the metal sheet 6 forms a residual part 13. The residual part 13 has been divided along separating lines 11 into a plurality of portions 12. Adjacent portions 12 are connected together via in each case at least one joint 14 in the separating line 11 running between the two portions 12. The residual part 13 can thus be removed as a whole from the support 4. For reasons of clarity, the joints 14 are here marked by dots which are wider than the lines which identify the separating lines 11; nevertheless, the joints 14 extend between the flanks of the two portions 12 adjoining the separating line 11, see FIG. 2. Typically, the workpieces 16 are removed before the residual part 13 is removed.

The individual portions 12 of the residual part 13 can then be separated from one another. The joints 14 are broken for this purpose. Owing to their small height h, this can be carried out manually. By shredding the residual part 13 into the individual portions 12, disposal is facilitated.

In some regions, the workpieces 16 can have a small spacing of, for example, less than 10 mm. In these regions 18 with small spacing too, the separating lines 11 can each be formed with a joint 14.

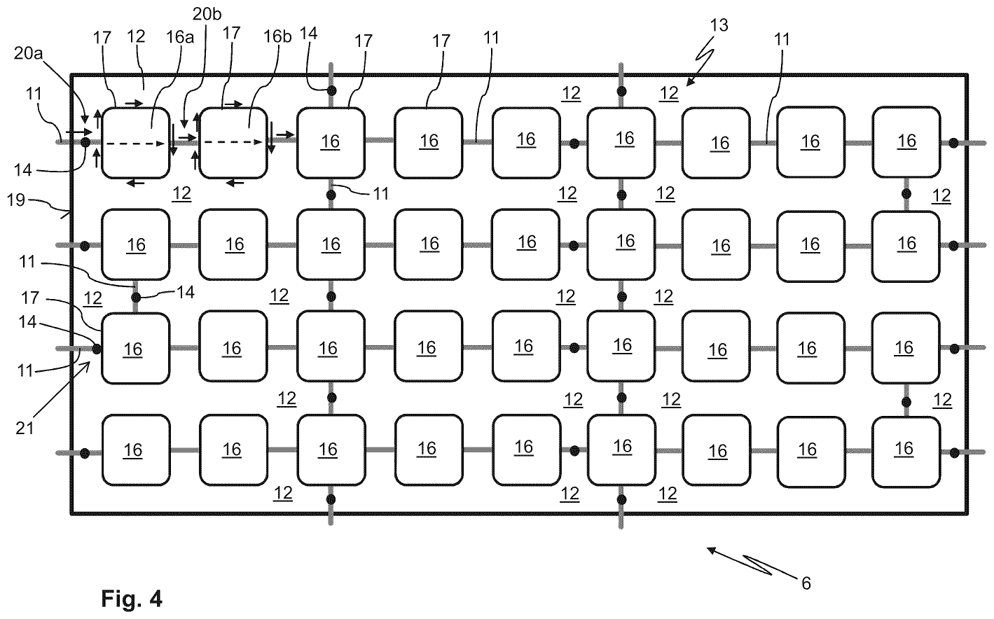

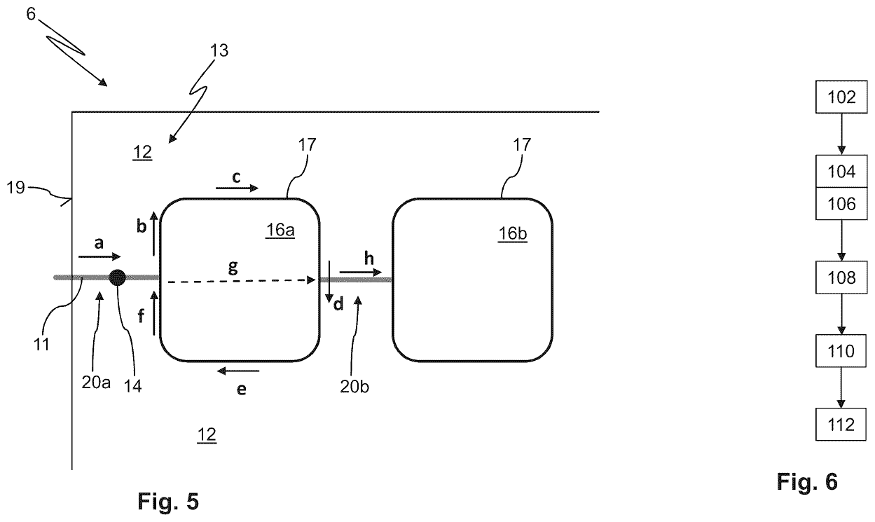

FIG. 4 shows a further metal sheet 6 with cutting lines 17, which surround workpieces 16, and with separating lines 11, which divide a residual part 13 into a plurality of portions 12. In the top left region of FIG. 4, a sequence of the cutting operation during introduction of the cutting lines 17 and of the separating lines 11 is indicated by means of arrows; this is shown on an enlarged scale in FIG. 5, wherein the sequence of processing over time is identified by the letters a to h.

The cutting operation here begins at an outer edge 19 of the metal sheet 6. Piercing of the metal sheet is not required. In order to make it clear that the laser beam 5 has already been switched on before it strikes the metal sheet 6, the separating lines 11 are shown extended outward beyond the edge 19. A first segment 20a of the separating line 11 is first introduced starting from the outer edge 19, see arrow a. The first segment 20a of the separating line 11 runs as far as a first workpiece 16a. Between the outer edge 19 and the workpiece 16a, a joint 14 is produced in the separating line 11.

As soon as the laser beam 5, as it introduces the separating line 11, has reached the workpiece 16a, the cutting line 17 is introduced around the workpiece 16a, see arrows b to f. To this end, the cutting operation continues without interruption. In other words, the first segment 20a of the separating line 11 and the cutting line 17 are produced in a continuous cutting operation.

Once the workpiece 16a has been cut out completely, the laser beam 5 is switched off. The processing head 3, with the laser beam switched off, is then moved to the beginning of a second segment 20b of the separating line 11, see arrow g.

The second segment 20b begins directly at the workpiece 16a in the region of the cutting line 17, which cuts through the metal sheet 6. Here too, piercing of the metal sheet 6 at the beginning of the cutting operation is not required. The cutting operation proceeds along the second segment 20b of the separating line 11 to a second workpiece 16b. The cutting line 17 around the second workpiece 16b can again be produced in a continuous cutting operation with the second segment 20b of the separating line 11.

Further segments of the separating line 11, or further separating lines 11, can be introduced and further workpieces 16 can be cut out in the manner described above. In the case of the metal sheet 6 of FIG. 4, all the cutting operations begin either at the outer edge 19 or at a point of the metal sheet 6 that has already been cut through completely by a cutting line 17 or a separating line 11.

The indicator arrow 21 shows by way of example that a joint 14 of small height can also be provided directly adjacent to a cutting line 17. Here too, the separating line 11 with the joint 14, and the adjacent cutting line 17 can be produced in a continuous cutting operation.

FIG. 6 shows a summarizing flow diagram of a process for cutting at least one workpiece 16, preferably a plurality of workpieces, out of a metal sheet 6, wherein a residual part 13 is left behind. The process can be carried out with the laser processing installation 50 of FIG. 1 and can serve, for example, for the processing of the metal sheets 6 according to FIG. 3 or FIG. 4.

In a step 102, the metal sheet is arranged on a support 4 of a laser cutting machine 1. This can be carried out by means of a loading and unloading apparatus 51.

In a step 104, at least one cutting line 17 is introduced into the metal sheet 6. The cutting line 17 separates the workpiece 16 from the residual part 13. In a step 106, at least one separating line 11 is introduced into the metal sheet 6. The separating line 11 divides the residual part 13 into a plurality of portions 12. At least one joint 14 which connects the mutually adjacent portions 12 of the residual part 13 to one another is formed in the separating line 11. The joint 14 has a height d which is smaller than a thickness D of the metal sheet 6.

Steps 104 and 106 can be carried in any sequence in succession or alternately. In particular, segments of the separating lines 11 and of the cutting lines 17 can merge into one another without interruption. In the case of an uninterrupted cutting operation or in the case of a plurality of separate cutting operations, it is possible to switch multiple times between the production of separating lines 11 and cutting lines 17.

Then, in a step 108, the workpieces 16 that have been cut out can be removed from the support 4. The loading and unloading apparatus 51 can be used for this purpose. The loading and unloading apparatus 51 can have a suction means for handling the workpieces 16.

Subsequently, in a step 110, the entire residual part 13 can be removed from the support 4. The portions 12 of the residual part 13 are here handled as a unit. This can be carried out with the loading and unloading apparatus 51. To this end, prongs of a gripper 52 can be pushed beneath the residual part 13 between support bars of the support 4

After the residual part 13 has been removed, it is shredded into the individual portions 12 in a step 112. To this end, the joints 14 are separated, for example broken.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Laser cutting machine 1
Laser beam generator 2
Processing head 3
Support 4
Laser beam 5
Metal sheet 6
Cutting gases 7
Suction device 8
Suction channel 9
Cutting gas nozzle 10
Separating line 11
Portion 12
Residual part 13
Joint (nanojoint) 14
Control device 15
Workpiece 16, 16a, 16b
Cutting line 17
Regions 18 with small spacing
Outer edge 19
Segments 20a, 20b
Indicator arrow 21
Laser processing installation 50
Loading and unloading apparatus 51
Gripper 52
Arranging 102 a metal sheet 6 on a support 4
Introducing 104 a cutting line 17
Introducing 106 a separating line 11
Removing 108 workpieces 16
Removing 110 a residual part 13
Separating 112 portions 12 of the residual part 13
Curve K
Thickness D of the metal sheet 6
Height d of the joints 14
Length L of the joints 14
Arrows a-h

1. A laser cutting process for cutting at least one workpiece out of a metal sheet while leaving a residual part,
the process comprising:
A) arranging the metal sheet on a support of a laser cutting machine;
B) introducing at least one cutting line for separating the at least one workpiece from the residual part using the laser cutting machine; and
introducing at least one separating line into the residual part using the laser cutting machine, wherein in a main region of the separating line, the residual part is cut through, and wherein in a connecting region of the separating line, at least one joint remains between mutually adjacent portions of the residual part, the joint having a height that is smaller than a thickness of the metal sheet;
C) removing the residual part from the support; and
D) separating the portions of the residual part from one another.

2. The process as claimed in claim 1, wherein a laser power is reduced in the connecting region of the separating line compared to the main region.

3. The process as claimed in claim 1, wherein the height of the joint is not more than half of the thickness of the metal sheet.

4. The process as claimed in claim 3, wherein the height of the joint is not more than one third of the thickness of the metal sheet.

5. The process as claimed in claim 1, wherein a length of the joint, measured along the separating line, is not more than half and/or at least one quarter of the thickness of the metal sheet.

6. The process as claimed in claim 1, further comprising removing the at least one workpiece from the support between steps B) and C).

7. The process as claimed in claim 1, wherein an uninterrupted separating length of the main region of the separating line is not more than 400 mm.

8. The process as claimed in claim 1, wherein in step B), two intersecting separating lines are introduced, and wherein at least one joint remains in each separating line at a point of intersection of the separating lines.

9. The process as claimed in claim 1, wherein the separating line reaches an outer edge of the metal sheet and intersects a further separating line or the at least one cutting line at a point of intersection, and wherein at least one joint remains between the point of intersection and the outer edge of the metal sheet.

10. The process as claimed in claim 1, wherein, when the at least one cutting line and the at least one separating line are introduced, cutting begins at an outer edge of the metal sheet or at a point of the metal sheet that has already been cut through.

11. The process as claimed in claim 1, wherein the separating line reaches the cutting line.

12. The process as claimed in claim 10, wherein the introduction of the cutting line and the introduction of the separating line are carried out in a continuous cutting operation.

13. The process as claimed in claim 11, wherein the joint is formed adjacent to the cutting line.

14. The process as claimed in claim 1, wherein the separating line with the joint is introduced between two workpieces which are spaced apart from one another by not more than 10 mm.

15. The process as claimed in claim 1, wherein the thickness of the metal sheet is at least 4 mm.

16. The process as claimed in claim 15, wherein the thickness of the metal sheet is at least 10 mm.

17. The process as claimed in claim 15, wherein the thickness of the metal sheet is at least 20 mm.

18. The process as claimed in claim 15, wherein the thickness of the metal sheet is at least 40 mm.

19. A laser processing installation comprising:
a laser cutting machine,
a loading and unloading apparatus, and
a control device, wherein the control device is programmed to activate the laser cutting machine and the loading and unloading apparatus to carry out steps A) to C) of the process as claimed in claim 1.
